(19) United States
(12) Patent Application Publication
(10) Pub. No.: US 2019/0261711 A1
(43) Pub. Date: Aug. 29, 2019

(54) MAGNETIC FASTENER

(71) Applicant: Sara Marie Yarger, Elmore, OH (US)

(72) Inventor: Sara Marie Yarger, Elmore, OH (US)

(21) Appl. No.: 16/282,664

(22) Filed: Feb. 22, 2019

Related U.S. Application Data
(60) Provisional application No. 62/635,894, filed on Feb. 27, 2018.
(60) Provisional application No. 62/641,263, filed on Mar. 9, 2018.
(60) Provisional application No. 62/736,199, filed on Sep. 25, 2018.

(51) Int. Cl. A41F 1/00; F16B 1/00

(52) U.S. Cl. CPC A41F 1/002; F16B 2001/0035; F16B 1/00

(57) ABSTRACT

A magnetic fastener including a female component and a male component, each of the female component and the male component coupled to a magnet. When assembled, the magnet of the male component and the magnet of the female component are magnetically engaged and cooperate to militate against undesired disengagement of the magnetic fastener.

### CROSS-REFERENCE TO RELATED PATENT APPLICATIONS

This patent application claims the benefit of U.S. Provisional Patent Application Ser. No. 62/635,894, filed on Feb. 27, 2018, U.S. Provisional Patent Application Ser. No. 62/641,263, filed Mar. 9, 2018, and U.S. Provisional Patent Application Ser. No. 62/736,199, filed Sep. 25, 2018. The entire disclosures of the above patent applications are hereby incorporated herein by reference.

### FIELD OF THE INVENTION

The present invention relates to a fastener. In particular, the invention is directed to a universally applicable magnetic fastener that implements a locking mechanism in order to maintain the fastener in a closed position.

### BACKGROUND OF THE INVENTION

Conventional fastener assemblies, such as straps, belts, bands and the like are commonly utilized to secure composite structures that require the assisted manual attachment of a male component to a female component. Generally, conventional fasteners impose a cumbersome dilemma upon a user, especially when utilized in such a specific way as in a horse halter or pet collar, for example. This is due to many factors that are prevalent whilst installing a fastener in such a way, like unpredictability of an animal's behavior and the wide surface area the fastener can potentially span that make the fastener difficult to couple and uncouple.

Magnetic fasteners have presented a widely used solution to the issues that are ubiquitously attributed to conventional fasteners. The convenience magnetic fasteners provide a user is perhaps the biggest reason magnetic fasteners have become a common replacement for conventional fasteners. Magnetic fasteners are usually constructed from a male component and a female component, each paired with complimentary magnets. Due to the nature of magnets, once a first component is within close proximity to the other component, the mutually attractive magnetic forces urge the two respective components together. When magnets are installed within a fastener system, this natural phenomenon aids in closing the fastener.

However, due to the characteristics of the inherent nature of magnetic attraction, it is understood that the magnetic coupling forces are generally strongest in the direction that is substantially normal, or perpendicular, to the coupling surfaces. In comparison, the mutual lateral attraction is relatively weak, and lateral dislocation of the magnetic components may occur relatively easily by lateral pulling of the magnetic components, which may cause inadvertent disengagement of the magnetic components when a lateral tension is applied. Many alternatives have been offered as ways to retard undesirable lateral movement. For example, frictional coupling surfaces or minimally apparent protrusions extending from the housing holding the magnets have been used. However, these options either conflict with the ease of self-alignment between the coupling surfaces or are not effective enough and are, therefore, not attractive options.

Further, magnets also have differing poles of attraction as part of a magnetic field, commonly known as a magnet's north and south poles. In effect, complimentary magnets naturally attract one another, but when like-poles are positioned to face one another these magnets repel one another.

Thus, it is desirable to provide a magnetic fastener that has a male component and a female component, each paired with a respectively complimentary magnet that may be universally applied to act as a fastener. It is also desirable to integrally formulate the female component with an apertured area that is purposed to receive the male component to militate against the inadvertent disengagement of the magnetic components.

### SUMMARY OF THE INVENTION

In concordance and agreement with the instant disclosure, a new magnetic fastener that provides an easy mechanism to fasten individual components to one another while militating against the inadvertent disengagement of the magnetic components, has surprisingly been discovered.

This new magnetic fastener comprises: a male component and a female component, each paired with a complimentary magnet predisposed to mutually attract one another when placed within proximal distance from each other. The female component of the magnetic fastener is constructed to accommodate an apertured area purposed to accept the male component of the magnetic fastener in order to prevent inadvertent disengagement of the two components in either the lateral or perpendicular directions once each respective component are fully engaged. In consideration of what is disclosed within the present invention, two variations of an embodiment are shown in regards to the female component to demonstrate the universal applications of this novel innovation.

### BRIEF DESCRIPTION OF THE DRAWINGS

The above-mentioned, and other features and objects of the inventions, and the manner of attaining them will become more apparent and the invention itself will be better understood by reference to the following description of an embodiment of the invention taken in conjunction with the accompanying drawings, wherein:

FIG. 1 is a fragmentary cross-sectional side elevational view of a magnetic fastener with a male component decoupled from a female component according to the invention;

FIG. 2 is a fragmentary cross-sectional side elevational view of the magnetic fastener illustrating the male component coupled with the female component;

FIG. 3 is a top plan view of the male component according to the invention without a magnet disposed thereon;

FIG. 4 is an exploded fragmentary side elevational view of the male component according to FIG. 3 with a magnet;

FIG. 5 is an exploded cross-sectional side elevational view of the female component according to the invention;

FIG. 6 is a top plan view of the female component according to FIG. 6;

FIG. 7 is a top plan view of a substantially cylindrical female component according to another embodiment of the invention;

FIG. 8 is an exploded perspective view of the female component according to FIG. 7; and

FIG. 9 is fragmentary perspective view of a magnetic fastener including the female component of the other embodiment of the invention according to FIGS. 7-8.

### DETAILED DESCRIPTION OF THE PREFERRED EMBODIMENT

The following detailed description and appended drawings describe and illustrate various exemplary embodiments of the invention. The description and drawings serve to enable one skilled in the art to make, and use the invention, and are not intended to limit the scope of the invention in any manner. With respect to the methods disclosed, the steps presented are exemplary in nature, and thus, the order of the steps is not necessary or critical.

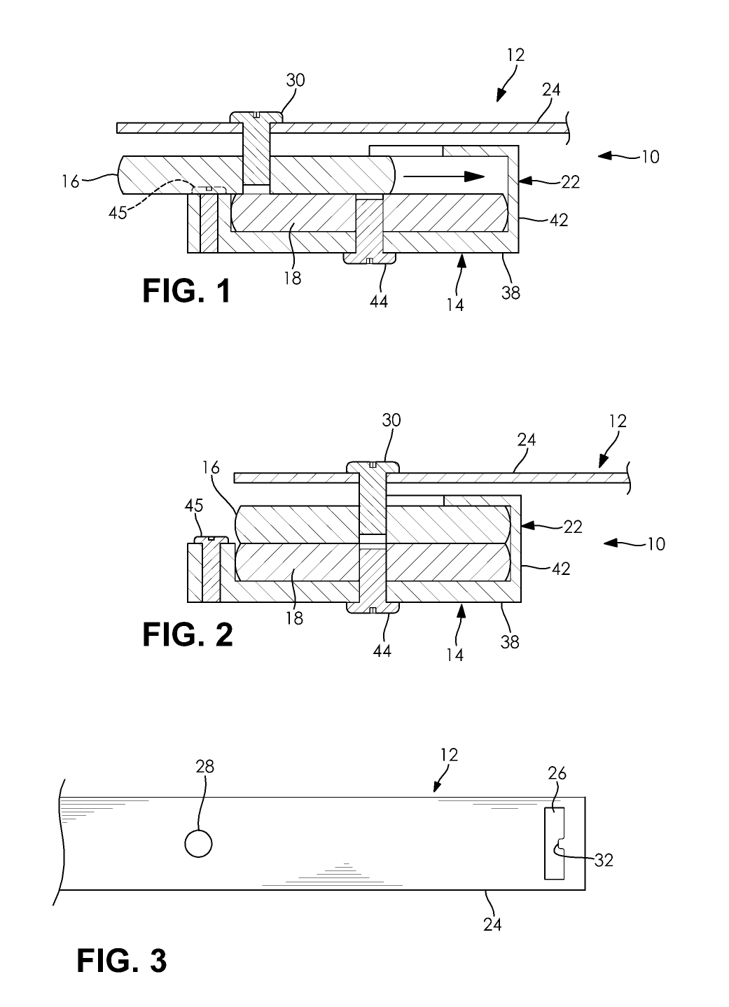

FIGS. 1 and 2 illustrate a magnetic fastener 10 including a male component 12 and a female component 14 according to an embodiment of the disclosure. The magnetic fastener 10 is configured to facilitate the coupling of complimentary magnets 16, 18 that are attached to the male component 12 and the female component 14, respectively. As illustrated, the magnetic fastener 10 is either in a first position 20 or a second position 22 dependent upon the proximity of the male component 12 from the female component 14. Due to the nature of magnetic fields, there is an inherent attraction between the complimentary magnets 16, 18 that compels an automated transition from the first position 20 to the second position 22, thereby closing the magnetic fastener 10.

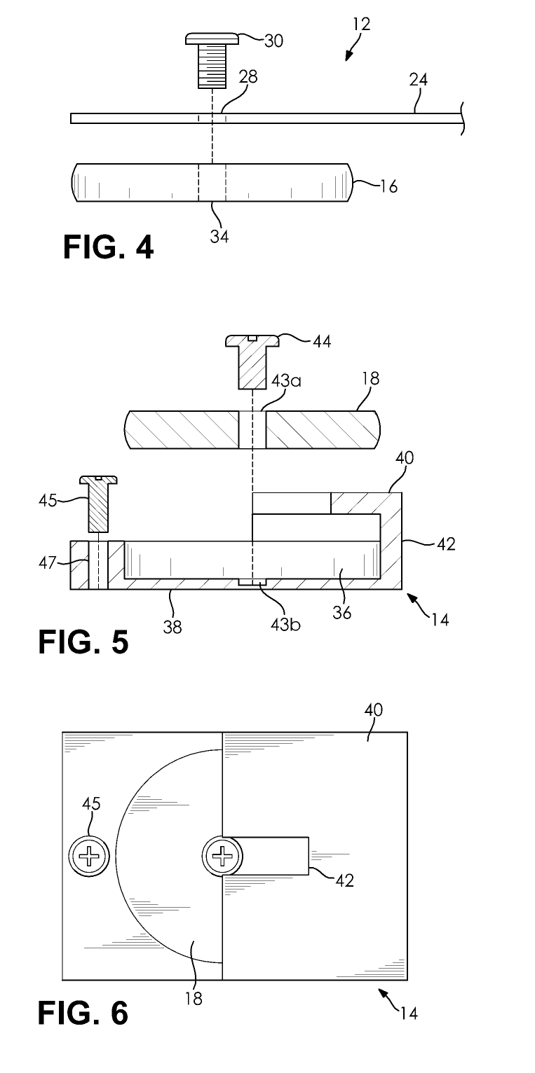

The male component 12, illustrated in FIGS. 3 and 4, includes a strap or a plate 24, a slot 26, an aperture 28, a fastener 30 and the magnet 16. The magnet 16 is configured to oppose the polar-specific positioning of the magnet 18 received within the female component 14. A specific positioning of the magnet 16 ensures the automated coupling intended, so the strap 24 is opposite and spaced from the female component 14. An abutment 32 is formed within the insert 26 to restrict or militate against inadvertent removal of an adjustable strap, belt, or other flexible material received within the slot 26. The adjustable strap can be a belt, a band, or other material, wherein it is desired to releasably fasten an object secured to the male component 12 to an object secured to the female component 14. For example, the objects can be articles of clothing, shoes, belts, an animal collar or halter and the like. Further, the aperture 28 is configured to receive the fastener 30 therein to secure the magnet 16 to the male component 12. The fastener 30 can be any fastener such as a bolt, a screw, a pin, a rivet and the like. An aperture 34 is formed in the magnet 16 and is also configured to receive the fastener 30 therein.

Referring to FIGS. 5 and 6, the female component 14 includes a cavity 36 formed in a base 38 thereof. The cavity 36 is configured to receive the magnet 18 therein. In the embodiment shown, the base 38 has a substantially rectangular shape and the cavity 36 has a substantially circular shape. However, it is understood other shapes can be used for both the cavity 36 and the base 38 without departing from the scope of the invention. Further, the base 38 is produced from a durable material such as a plastic or a polymeric material, for example, but other materials can be used without departing from the scope of the invention. The female component 14 also includes a hooded portion 40 extending radially inwardly from a peripheral wall 42 forming the cavity 36 to a point intermediate the peripheral wall 42, and is substantially parallel with the floor of the base 38. The hooded portion 40 defines a pocket therein adjacent the cavity 36 and is configured to receive the magnet 16 of the male component 12 therein. Further, the hooded portion 40 includes a slot 42 formed therein configured to receive the fastener 30 therein as shown in FIG. 2. Apertures 43a, 43b are respectively formed within the magnet 18 and in the base 38. Each of the apertures 43a, 43b is configured to receive a fastener 44 therein, thereby securing the magnet 18 and the base 38 to one another. The fastener 44 can be any fastener such as a bolt, a screw, a pin, a rivet and the like. It is understood the magnet 18 can be secured in the female component 14 by any method such as by press fitting, using an adhesive, and the like as desired without departing from the scope of the invention. The female component 14 also includes an insert 47 that is configured to receive a fastener 45 to facilitate securing a strap to the base 38 of the female component 14. The fastener 45 can be any fastener such as a bolt, a screw, a pin, a rivet and the like. It is understood that any means can be used, such as a slot, to secure the strap to the base 38 of the female component 14. The strap can be a belt, a band, or other material configured to have a distal end secured to the object to be secured to the female component, wherein it is desired to releasably fasten the object secured to the female component 14 to the object secured to the male component 12.

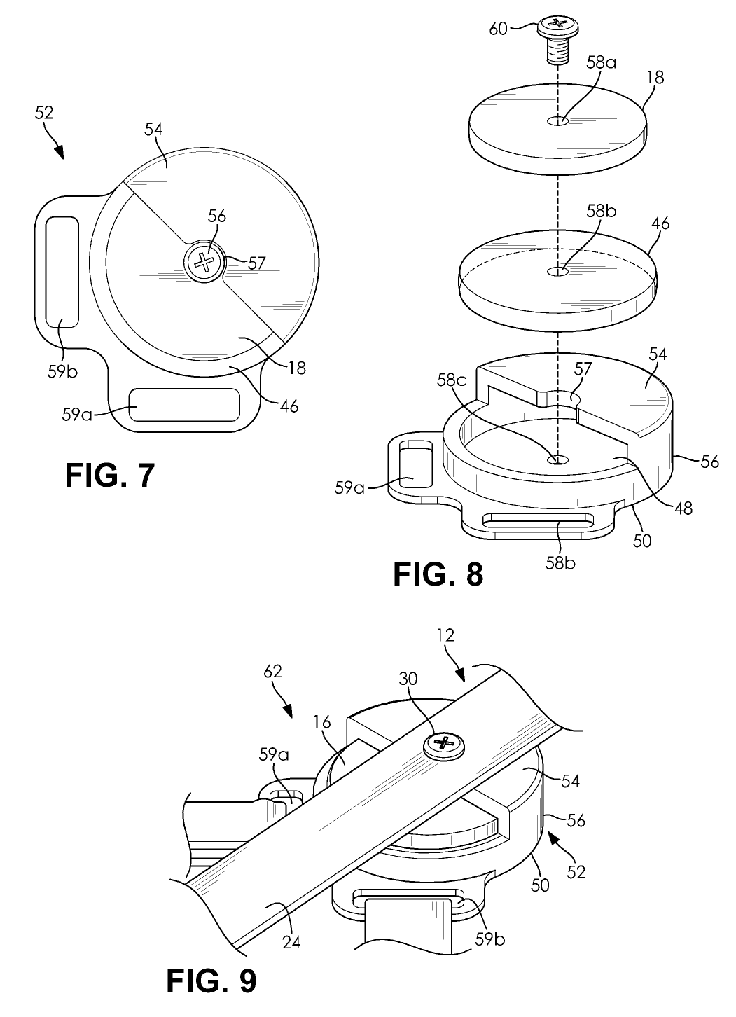

In another embodiment shown in FIGS. 7 and 8, a female component 52 can be configured to include a capsule 46, and a cavity 48 formed in a base 50. The capsule 46 is configured to receive the magnet 18 therein. Additionally, the cavity 48 is configured to receive the capsule 46 therein. In the embodiment shown, the base 50 has a substantially cylindrical shape and both the cavity 48 and the capsule 46 each have a substantially circular shape. However, it is understood other shapes can be used for both the cavity 48 and the base 50 without departing from the scope of the invention. Further, the base 50 is produced from a durable material such as a plastic or a polymeric material, for example, but other materials can be used without departing from the scope of the invention. The female component 52 also includes a hooded portion 54 extending radially inwardly from a peripheral wall 56 forming the cavity 48 and terminating at a point intermediate the peripheral wall 56. The hooded portion 54 is substantially parallel with the floor of the base 50 and defines a pocket therein adjacent the cavity 48 configured to receive the magnet 18 therein. Further, the hooded portion 54 includes a slot 57 formed therein configured to receive the fastener 30 therein as show in FIG. 9. A plurality of apertures 58a, 58b, 58c is respectively formed within the magnet 18, the capsule 46, and the base 50. Each of the apertures 58a, 58b, 58c is configured to receive a fastener 60 therein, thereby securing the magnet 18, the capsule 46 and the base 50 to one another. The fastener 60 can be any fastener such as a bolt, a screw, a pin, a rivet and the like. It is understood the magnet 18 can be secured in the female component 52 by any method as desired such as by press fitting, use of an adhesive, and the like without departing from the scope of the invention. The female component 52 also has a plurality of slots 59a, 59b configured to receive a plurality of straps within them. The plurality of straps can be a plurality of belts, a plurality of bands, or other materials, wherein it is desired to releasably fasten the object secured to the female component 52 to the object secured to the male component 12.

FIG. 9 illustrates a magnetic fastener 62 including the male component 12 and the female component 52 according to an alternate embodiment of the disclosure. The magnetic fastener 62 is configured to facilitate coupling of the plurality of complimentary magnets 16, 18 attached to the male component 12 and the female component 52, respectively. The magnetic fastener 62, as illustrated, shows the male component 12 and the female component 52 fully coupled to one another due to an inherent magnetic attraction prevalent within each of the complimentary magnets 16, 18.

The magnetic fastener 10, 62 is closed once a full coupling of the magnets 16, 18 occur and the fastener 30 is fully engaged with the slot 42, 57. During installation of the magnetic fastener 10, 62, the female component 14, 52 is positioned in anticipation of which direction the strongest axial load would likely be imposed so that in the event of an applied force, the stress of the force will cause the male component 12 to abut the peripheral wall 42, 56 of the female component 14, 52. Consequently, the peripheral wall 42, 56 militates against relative movement between the male component 12 and the female component 14, 52 due to axial loads imposed upon the magnetic fastener 10, 62, preventing inadvertent disengagement of the male component 12 from the female component 14, 52. However, when a user uninstalls the magnetic fastener 10, 62 an intentional removal of the male component 12 from the female component 14, 52 in the direction opposite the peripheral wall 42, 56 requires a minimal force. Also, the hooded portion 40, 54 further prevents inadvertent disengagement in the presence of a lateral load, as the hooded portion 40, 54 prevents the magnet 16 of the male component 12 from detaching from the magnet 18 attached to the female component 14, 52.

The magnetic fasteners 10, 62 provide advantages over fasteners of prior art. For example, the magnetic fasteners 10, 62 replace complex mechanical fasteners that may be difficult for some individuals to manipulate to release. For an individual with a physical disability, the fastener or the present invention greatly increases a freedom, mobility and accessibility to the individual by making tasks involving manipulation of the fastener easier.

Although the embodiments shown and described herein are used for a fastener for a belt, a strap, a band and the like, it is understood that the fastener can be used with other objects and in other applications as desired, for example an animal collar or halter.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A magnetic fastener comprising:
a female component with a cavity formed therein configured to receive a first magnet therein, the female component including a hood bounded by a peripheral wall and extending radially inwardly from the peripheral wall, the hood forming a pocket therein; and
a second magnet configured to be received in the pocket formed by the hood of the female component and magnetically engage with the first magnet.

2. The magnetic fastener of claim 1, further comprising a fastener coupling a male component to the second magnet.

3. The magnetic fastener of claim 2, wherein the hood of the female component includes a slot formed therein configured to receive the fastener coupling the male component to the second magnet.

4. The magnetic fastener of claim 3, wherein the hood restricts a lateral movement of the male component when the fastener is received in the slot.

5. The magnetic fastener of claim 3, wherein the hood restricts a magnetic disengagement of the first magnet from the second magnet when the fastener is received in the slot.

6. The magnetic fastener of claim 1, wherein the female component is produced from a durable material such as a plastic or a polymeric material.

7. A magnetic fastener comprising:
a female component with a cavity formed therein configured to receive a capsule therein, the capsule including a first magnet disposed therein, the female component including a hood bounded by a peripheral wall and extending radially inwardly from the peripheral wall, the hood forming a pocket therein; and
a male component coupled to a second magnet configured to be received in the pocket formed by the hood of the female component and magnetically engage with the first magnet.

8. The magnetic fastener of claim 7, further comprising a fastener coupling the male component to the second magnet.

9. The magnetic fastener of claim 8, wherein the hood of the female component includes a slot formed therein configured to receive the fastener coupling the male component to the second magnet.

10. The magnetic fastener of claim 9, wherein the slot restricts a lateral movement of the male component when the fastener is received in the slot.

11. The magnetic fastener of claim 9, wherein the slot restricts a magnetic disengagement of the first magnet from the second magnet when the fastener is received in the slot.

12. The magnetic fastener of claim 7, wherein the female component is produced from a durable material such as a plastic or a polymeric material.

13. A magnetic fastener comprising:
a female component with a cavity formed therein configured to receive a first magnet therein, the female component including a hood bounded by a peripheral wall and extending radially inwardly from the peripheral wall, the hood forming a pocket therein; and
a male component coupled to a second magnet configured to be received in the pocket formed by the hood of the female component and magnetically engage with the first magnet, the male component including a slot configured to receive an object that is configured to secure the male component to the female component the female component including a slot configured to receive an object that is configured to secure the female component to the male component.

14. The magnetic fastener of claim 14, further comprising a fastener coupling the male component to the second magnet.

15. The magnetic fastener of claim 15, wherein the hood of the female component includes a slot formed therein configured to receive the fastener coupling the male component to the second magnet.

16. The magnetic fastener of claim 16, wherein the slot restricts a lateral movement of the male component when the fastener is received in the slot.

17. The magnetic fastener of claim 16, wherein the slot restricts a magnetic disengagement of the first magnet from the second magnet when the fastener is received in the slot.

18. The magnetic fastener of claim 14, wherein the female component is produced from a durable material such as a plastic or a polymeric material.
